(19) United States
(12) Patent Application Publication
(10) Pub. No.: US 2025/0145535 A1
(43) Pub. Date: May 8, 2025

(54) METHOD AND DEVICE FOR PRODUCING A SILICON CARBIDE-COMPRISING WORKPIECE

(71) Applicant: The Yellow SiC Holding GmbH, Berlin (DE)

(72) Inventor: Siegmund GREULICH-WEBER, Berlin (DE)

(73) Assignee: The Yellow SiC Holding GmbH, Berlin (DE)

(21) Appl. No.: 18/832,127

(22) PCT Filed: Jan. 27, 2023
(86) PCT No.: PCT/EP2023/052015

§ 371 Date: Jul. 23, 2024

(30) Foreign Application Priority Data
Jan. 28, 2022 (DE) 10 2022 102 091.6

(51) Int. Cl. C04B 35/565

(52) U.S. Cl. CPC C04B 35/565; C04B 2235/3826; C04B 2235/614

(57) ABSTRACT

Disclosed are a method and an apparatus for manufacturing a silicon carbide-containing workpiece, in which:
a carbon-containing shaped body (2) is held in a first reactor (1) at a first temperature which permits the transformation of the shaped body (2) into the silicon carbide-containing workpiece,
a precursor containing carbon and silicon is fed into a second reactor (3) which is maintained at a second temperature which is higher than the first temperature and causes the precursor to be converted to a Si—C-containing gas, and
the Si—C-containing gas is fed from the second reactor (3) into the first reactor (1) to the shaped body (2) held in the first reactor (1) at the first temperature, and the shaped body (2) is thereby transformed into the silicon carbide-containing workpiece.

The invention relates to a method and an apparatus for manufacturing a silicon carbide-containing workpiece.

EP 2094622 B1 discloses a method for manufacturing a silicon carbide-containing workpiece in which a shaped body (blank) of carbon-containing material with essentially the shape and dimensions of the silicon carbide-containing workpiece to be manufactured is placed in a furnace and surrounded by a precursor that includes SiO₂ containing carbon. The carbon-containing material of the shaped body can be graphite, for example, which can be easily machined and provided in the shape of the workpiece to be manufactured. The precursor can be a granulate of carbon-rich SiO₂.

Alternatively, the shaped body can also be coated with a carbon-containing SiO₂ gel as a precursor.

In the technique known from EP 2094622 B1, the shaped body is embedded in the carbon-rich SiO₂ precursor or at least partially surrounded by it. The precursor and shaped body are then exposed to a temperature of around 1800° C. under a protective gas atmosphere in the furnace. The starting materials are converted to silicon carbide, among other things, and the workpiece containing silicon carbide is thus created from the shaped body.

This transformation takes place under the following carbothermal reactions:

C+SiO₂→SiO+CO

SiO₂+CO→SiO+CO₂

C+CO₂→2CO

SiO+2C→SiC+CO

In the course of those reactions, Si—C-containing gas should diffuse from the precursor into the shaped body. However, the SiO₂ precursor and the shaped body are at the same temperature level in the furnace, and the Si—C-containing gas therefore diffuses from the precursor in all spatial directions, which leads to a rather random chemical reaction of the SiO₂ with the carbon atoms of the shaped body. Moreover, the SiO₂ precursor is all exposed to a high temperature during this process, which severely limits the time for a carbo thermal reaction in the shaped body, because the precursor is used up quickly, i.e. within a few seconds in practice, and around 90% of the available precursor ends up in areas of the furnace with slightly lower temperatures, where it reacts to form SiC without being available for workpiece production. Only a small proportion of it reacts under formation of SiC in the shaped body. The process must therefore be repeated many times in order to achieve an SiC transformation of the shaped body at least close to the surface. This is very time-consuming and energy-intensive due to the refilling of the precursor and the necessary cooling and heating times of the furnace. Overall, the proposed process is very ineffective in every respect.

It is, therefore, an object of the invention to provide a more effective technique for manufacturing a workpiece containing silicon carbide.

This object is solved by a method and an apparatus as set forth in the appended claims.

The success of the invention in solving the underlying object is based on the presence of two reactors, of which the first reactor receives the shaped body and the second reactor is used to convert the precursor into a gas, which is fed from there directly into the first reactor. This enables a continuous, successive supply of the precursor and its controlled feeding to the shaped body and thus an efficient production process in which the shaped body is transformed into the silicon carbide-containing workpiece.

Preferred embodiments of the invention are described below with reference to the drawing in which:

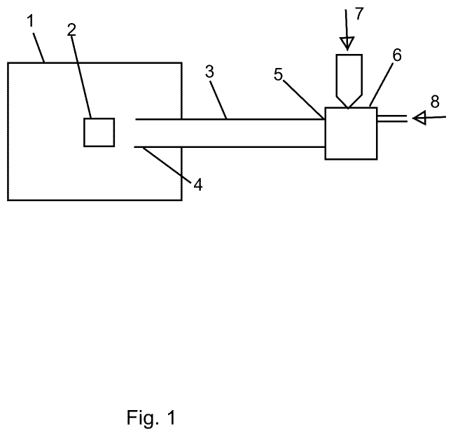

FIG. 1 schematically shows an apparatus for manufacturing a silicon carbide-containing workpiece according to embodiments of the invention.

The apparatus for manufacturing a silicon carbide-containing workpiece as shown in FIG. 1 comprises a furnace serving as a heatable first reactor 1, which accommodates a shaped body 2 made of carbon-containing material. The shaped body 2 is a blank with essentially the shape and dimensions of the silicon carbide-containing workpiece to be manufactured. A suitable carbon-containing material is graphite, which can be easily machined and provided in the shape of the workpiece to be manufactured.

A second reactor 3, which can also be heated, is connected to the first reactor 1 and has the shape of a tube. The tube-shaped second reactor 3 has an outlet 4 at one end, which is arranged in the first reactor 1 near the shaped body 2. At its other end, outside the first reactor 3, the second reactor 3 has an inlet 5, which is connected to a conveyor 6. The conveyor 6 is filled with a precursor from the direction of arrow 7 and is supplied with a controlled flow of an inert gas from the direction of arrow 8.

The precursor contains silicon and carbon. The precursor is preferably present as a solid, in particular as a powder or granulate of SiO₂ containing carbon, i.e. being mixed with carbon or a carbon compound, whereby a powder conveyor 6 is used as the conveyor 6 as shown in the figure. Alternatively, the precursor containing Si and C can also be supplied in liquid or gaseous form, in which case a pump is used as the conveyor 6. Any dopants and alloys for the workpiece to be manufactured can be introduced into the process in the form of additives to the precursor.

The inert gas is argon, for example. The conveyor 6 is used to supply the precursor, together with the inert gas if needed, through the inlet 5 into the second reactor 3. The inert gas can also be supplied separately to the second reactor 3.

The second reactor 3 is used to heat the supplied precursor and transform it into the gas phase, whereby a gas containing Si and C is produced. The precursor transformed into the gas phase in this way is fed directly to the shaped body 2 in the first reactor 1, with support by the flow of inert gas, whereby the shaped body is transformed into the silicon carbide-containing workpiece. These processes take place according to the carbothermal reactions mentioned above.

Since the second reactor 3 is tubular and leads directly into the first reactor 1, it not only fulfills the function of a heated reactor for triggering the carbo thermal reactions, but also the function of a conduct for introducing the precursor, which has been transformed into the gas phase, into the first reactor 1.

The second reactor 3 is preferably made of a tube or pipe made of silicon carbide, so that the substances conveyed by the conveyor 6 and transformed into the gas phase in the second reactor 3 do not come into contact with other materials and do not become contaminated. The second reactor 3 is preferably heated by passing electric current through this silicon carbide tube.

The second reactor 3 can also be understood as an effusion cell modified in such a way that it has the features mentioned above.

In order to efficiently direct the Si—C-containing gas to the shaped body 2, the outlet 4 of the second reactor 3 or the effusion cell is directed towards the shaped body 2. Several second reactors 3 or effusion cells can also be provided, the outlets 4 of which are directed from different directions to different sides of the shaped body 2 in order to expose it as completely as possible to the Si—C-containing gas.

During operation of the device, the following process is carried out to transform the carbon-containing shaped body 2 into the silicon carbide-containing workpiece:

The carbon-containing shaped body 2 is held in the first reactor 1 at a temperature that allows the shaped body 2 to be transformed into the silicon carbide-containing workpiece, preferably a temperature in the range from 1500 to 1700° C. The second reactor 3 is heated to a temperature that is higher than the temperature of the shaped body 2, preferably in the range of 1600 to 1800° C. The precursor is continuously metered and fed from the conveyor 6 through the inlet 5 into the second reactor 3, and the inert gas is also introduced into the second reactor 3 through the inlet 5 at the same time. At the temperatures mentioned herein, the precursor is transformed to the gas phase in the second reactor 3 to form a Si—C-containing gas, which is flushed with the inert gas through the outlet 4 to the shaped body 2, whose carbon is converted to silicon carbide by the Si—C-containing gas. The transformation of the precursor into the gas phase and the conversion of the carbon to silicon carbide take place at the specified temperatures according to the carbothermal reactions specified above. In this process, the carbon-containing shaped body 2, suitably made of graphite, is converted (transformed) into silicon carbide in its depth and not merely thinly coated with silicon carbide as in CVD or PVD processes.

The embodiments have the following advantageous properties:

The second reactor 3 or the effusion cell is designed in such a way that successive or continuous external replenishment of the precursor is possible, and only the portion of the precursor replenished in the second reactor 3 can thermally transit into the gas phase. This successive delivery of the precursor takes place via the conveyor 6. The geometric arrangement of the shaped body 2 and the second reactor 3 is selected so that the temperature gradient between the two leads to a highly efficient transport of the Si—C-containing gas to the shaped body 2 and to a highly efficient SiC transformation in the shaped body 2. Direct contact between the shaped body 2 and the precursor prior to the transition of the precursor into the gas phase is not necessary.

Since transport of the precursor by the conveyor 6 is conducted through the second reactor 3 together with inert gas, this flow of gas can be applied advantageously in a directed manner, so that not only thermal flow or convection is used for applying the gas to the carbon-containing shaped body 2, but the shaped body 2 is flushed with a directed flow of the Si—C-containing gas.

Gasification of the Si—C precursor supplied as a solid takes place in the second reactor 3, which is separate from the first reactor 1, and the resulting gas is fed to the graphite shaped body 2 via a heated feed line. The second reactor 3 and the heated feed line to the first reactor can be different from each other. Advantageously, however, the heated feed line itself serves as the second reactor 3 or effusion cell.

The process enables precise pressure control and mass flow regulation of the gas supplied to the shaped body 2 by regulating the supply of the inert gas and of the precursor to the second reactor 3 and by regulating the temperature of the second reactor 3. The temperature of the shaped body 2 or of the resulting workpiece and the temperature distribution in the first reactor 1 or furnace can be selected independently of the precursor gasification temperature in the second reactor 3. In this way, optimum conditions can be set, in particular conditions in which the precursor at the site of its gasification is not transformed into SiC, but the produced gas mixture of carbon compounds and silicon compounds is fed to the workpiece 2 without prematurely reacting to form SiC. If necessary, a small amount of oxygen can be added to the gas mixture.

The heated feed line for gas between the first and second reactors 1, 3 or the second reactor 3, which itself serves as a gas feed line, is made of an SiC tube that is itself acting as an electrical heating element. The temperature of the tube can be adjusted via the electric current through this SiC tube, and the gas pressure in the first reactor 1 can also be controlled via the temperature thus set.

Compared to gas deposition methods such as CVD or PVD, the particle flow supplied continuously by the conveyor 6 and thus the gas flow into the first reactor 1 is significantly higher. The invention is not only suitable for depositing a thin surface layer of SiC on the shaped body 2, but also for efficiently transforming the shaped body as such into the silicon carbide-containing workpiece.

1. A method of manufacturing a silicon carbide-containing workpiece, comprising:
holding a carbon-containing shaped body (2) in a first reactor (1) at a first temperature which permits the transformation of the shaped body (2) into the silicon carbide-containing workpiece,
supplying a carbon- and silicon-containing precursor into a second reactor (3) which is maintained at a second temperature which is higher than the first temperature and causes the precursor to be converted to a Si- and C-containing gas, and
feeding the gas containing Si and C from the second reactor (3) into the first reactor (1) to the shaped body (2) held at the first temperature in the first reactor (1), and thereby transforming the shaped body (2) into the workpiece containing silicon carbide.

2. A method according to claim 1, wherein the first temperature is in the range from 1500 to 1700° C. and the second temperature is in the range from 1600 to 1800° C.

3. A method according to claim 1, wherein the gas containing Si and C is continuously fed from the second reactor (3) into the first reactor (1).

4. A method according to claim 1, wherein the precursor is continuously fed into the second reactor (3).

5. A method according to claim 1, wherein the precursor is in powder form and is conveyed into the second reactor (3) by means of a powder conveyor (6).

6. A method according to claim 1, wherein an inert gas is fed through the second reactor (3) into the first reactor (1), with which the Si- and C-containing gas is continuously flushed from the second reactor (3) into the first reactor (1).

7. A method according to claim 1, wherein the second reactor (3) comprises a tube of SiC-containing material which is heated to the second temperature and into which the precursor and optionally the inert gas are introduced.

8. An apparatus for manufacturing silicon carbide, comprising:
a first reactor (1) configured to hold a carbon-containing shaped body (2) at a first temperature which allows the transformation of the shaped body (2) into the silicon carbide-containing workpiece, and
a second reactor (3) configured to heat a carbon- and silicon-containing precursor conveyed into it to a second temperature which is higher than the first temperature and causes the precursor to be converted into a Si- and C-containing gas,
the first and second reactors (1, 3) being connected to one another in such a way that the gas containing Si and C from the second reactor (3) is fed into the first reactor (1) to the shaped body (2) held at the first temperature in the first reactor (1), and the shaped body (2) is thereby transformed into the silicon carbide-containing workpiece.

9. An apparatus according to claim 8, comprising a conveyor (6) for continuously conveying the precursor into the second reactor (3).

10. An apparatus according to claim 8, comprising a device for continuously feeding inert gas through the second reactor (3) into the first reactor (1).
